(19) United States
(12) Patent Application Publication
(10) Pub. No.: US 2009/0080952 A1
(43) Pub. Date: Mar. 26, 2009

(54) Belt Fuser Assembly Having Feature To Prevent Media Wrapping Of The Fuser Belt

(76) Inventors: Russell Edward Lucas, Lexington, KY (US); Casey Thomas Wilson, Augusta, GA (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/860,694

(22) Filed: Sep. 25, 2007

(51) Int. Cl. G03G 15/20

(52) U.S. Cl. 399/322; 399/329

(57) ABSTRACT

A belt fuser assembly includes a housing, and a fuser belt rotatably mounted to the housing, with the fuser belt having a direction of rotation. A pivot body has a proximal portion pivotably mounted to the housing and has a first elongate member having a first distal end that extends from the proximal portion. The first elongate member has a width extending perpendicular to the direction of rotation of the fuser belt. The first distal end of the first elongate member has a smooth curved surface extending along the width for pressing against the fuser belt during a sheet jam occurring in the housing to prevent a sheet of media from wrapping around the fuser belt.

### CROSS-REFERENCE TO RELATED APPLICATIONS

None.

### MICROFICHE APPENDIX

None.

### GOVERNMENT RIGHTS IN PATENT

None.

### BACKGROUND OF THE INVENTION

1. Field of the Invention

The present invention relates to electrophotographic imaging devices, and, more particularly, to a belt fuser assembly having a feature to prevent media wrapping of the fuser belt.

2. Description of the Related Art

An electrophotographic imaging apparatus, such as a laser printer, forms a latent image on a surface of a photoconductive material by selectively exposing an area of the surface to light. The latent electrostatic image is developed into a visible image by electrostatic toners which contain pigment components and thermoplastic components. The photoconductor may be either positively or negatively charged, and the toner system similarly may contain negatively or positively charged particles. A print medium (e.g., a sheet of paper) or intermediate transfer medium is given an electrostatic charge opposite that of the toner and then passed close to a surface of the photoconductor, pulling the toner from the photoconductor onto the paper or immediate medium in the pattern of the image developed from the photoconductor. After the image is transferred to the print medium, the print medium is processed through a fuser assembly where it is heated and pressed.

Referring to FIG. 1A, a prior art belt fuser assembly 10, for example, includes a housing 12 which mounts a fuser belt 14 and a driven backup roller 16. Fuser belt 14 and driven backup roller 16 engage to form a fuser nip 18. Housing 12 includes an upper exit guide 12-1 and a lower exit guide 12-2. Housing 12 further mounts an exit roller 20 and a corresponding idler roller 22. Exit roller 20 and idler roller 22 engage to form an exit nip 24. Fuser belt 14, subjected to heat, melts and fixes the toner to the surface of the sheet of media 26, such as paper, thereby producing the printed image.

Fuser belt 14 of the belt fuser assembly 10 may be, for example, a polyimide tube having a Teflon® coating. Fuser belt 14 is rotated in a direction of rotation 15 by the sheet of media 26 moving through fuser nip 18 produced by backup roller 16 being pressed against fuser belt 14. A media feed direction is indicated by the arrows on the sheet of media 26. A ceramic heater (not shown) is positioned in the interior of fuser belt 14.

In a belt fuser assembly system, media sticking to the fuser belt typically has not been a problem. The flat nip of the belt fusing system greatly decreases the tendency of the media to curve, stick, and then wrap on the fuser belt. However, particularly in some small printers with very tight paper path architecture, it has been found that paper jams just beyond the fuser belt can propagate into a fuser wrap. The following describes the sequence of events typically leading to a fuser belt wrap.

Referring to FIG. 1A, during normal operation the sheet of media 26 exits belt fuser assembly 10 between exit roll 20 and idler roll 22. It is possible for the leading edge of the sheet of media 26 to become jammed, or strike an obstruction, downstream from exit nip 24 or in an exit region 28 of belt fuser assembly 10. In most cases the jam will result in media deformation and media jam recognized normally by the imaging apparatus, e.g., printer, in which belt fuser assembly 10 is installed. However, in some cases, the sheet of media 26 will jam in the exit region 28 with enough force to stall idler roller 22. This will result in the sheet of media 26 losing exit drive force, and therefore the sheet of media 26 becomes stalled in exit nip 24.

Referring to FIG. 1B, although the sheet of media 26 is not being driven by exit nip 24, the fusing nip 18 continues to drive the sheet of media 26. The continual feed by fusing nip forces the sheet of media 26 toward exit region 28 due to the stalled exit nip 24, and the paper is then forced to fill the exit region 28 prior to exit nip 24. During this time the sheet of media 26 can potentially begin to feed perpendicular to the intended media feed direction, which can lead to the sheet of media 26 feeding between the upper exit guide 12-1 and fuser belt 14 into region 30.

Referring to FIG. 1C, once the sheet of media 26 begins to feed in region 30, the sheet of media 26 will continue to feed in the direction of rotation 15 of fuser belt 14. Referring to FIG. 1D, the sheet of media 26 will feed this way until a portion of the sheet of media 26 re-enters the fuser nip 18. After the sheet of media 26 has re-entered the fuser nip 18 the large drive force seen there will then reverse the direction of the sheet of media 26 stalled in the exit nip 24, and will result in a complete media wrap of fuser belt 14.

The previously used method of contact de-tack fingers will not work against a polyimide fuser belt, since the fuser belt is not a solid member and thus cannot support the load. Accordingly, a polyimide fuser belt will be easily damaged by the de-tack fingers causing failure of the fuser belt.

Furthermore, non-contact de-tack fingers cannot be used with a polyimide belt fusing system, as the polyimide belt is flexible and is not in a predictable radial position as compared to a rigid hot roll. This is because there is a clearance that must be maintained between the fuser belt and the inner belt support structure that allows the fuser belt to “float” in and out within the given clearance. Therefore the tightly controlled clearance of a non-contact de-tack finger to the belt is impossible to maintain.

What is needed in the art is a belt fuser assembly having a feature to effectively and reliably prevent media wrapping of the fuser belt.

### SUMMARY OF THE INVENTION

The present invention provides belt fuser assembly having a feature to effectively and reliably prevent media wrapping of the fuser belt. Advantageously with respect to the prior methods described above, the present invention effectively and reliably prevents media wrapping of the fuser belt without damaging the fuser belt, and does not require a tightly controlled clearance to the fuser belt in order to function correctly. In addition, the exemplary embodiment disclosed herein is cost effective to implement, and does not require biasing springs or fasteners.

The terms “first” and “second” preceding an element name, e.g., first elongate member, second elongate member, etc., are used for identification purposes to distinguish between similar or related elements, and are not intended to necessarily imply order, nor are the terms “first” and “second” intended to preclude the inclusion of additional similar or related elements.

The invention, in one form thereof, is directed to a belt fuser assembly. The belt fuser assembly includes a housing. A fuser belt is rotatably mounted to the housing, with the fuser belt having a direction of rotation. A pivot body has a proximal portion pivotably mounted to the housing and has a first elongate member having a first distal end that extends from the proximal portion. The first elongate member has a width extending perpendicular to the direction of rotation of the fuser belt. The first distal end of the first elongate member has a smooth curved surface extending along the width for pressing against the fuser belt during a sheet jam occurring in the housing to prevent a sheet of media from wrapping around the fuser belt.

The invention, in another form thereof, is directed to an imaging apparatus for forming a toner image on a sheet of media. The imaging apparatus includes a media feed section for feeding the sheet of media along a media feed path in a sheet feed direction. A laser scanning device is configured to produce a scanned light beam. An image-forming device has a photosensitive body, and is configured to use the scanned light beam to form a latent image on the photosensitive body and develop the latent image to form a toner image that is transferred to the sheet of media. A belt fuser assembly fuses the toner image to the sheet of media. The belt fuser assembly includes a housing. A fuser belt is rotatably mounted to the housing, with the fuser belt having a direction of rotation. A pivot body has a proximal portion pivotably mounted to the housing and has a first elongate member having a first distal end that extends from the proximal portion. The first elongate member has a width extending perpendicular to the direction of rotation of the fuser belt. The first distal end of the first elongate member has a smooth curved surface extending along the width for pressing against the fuser belt during a sheet jam occurring in the housing to prevent a sheet of media from wrapping around the fuser belt.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIGS. 1A-1D illustrate media wrapping in a prior art belt fuser.

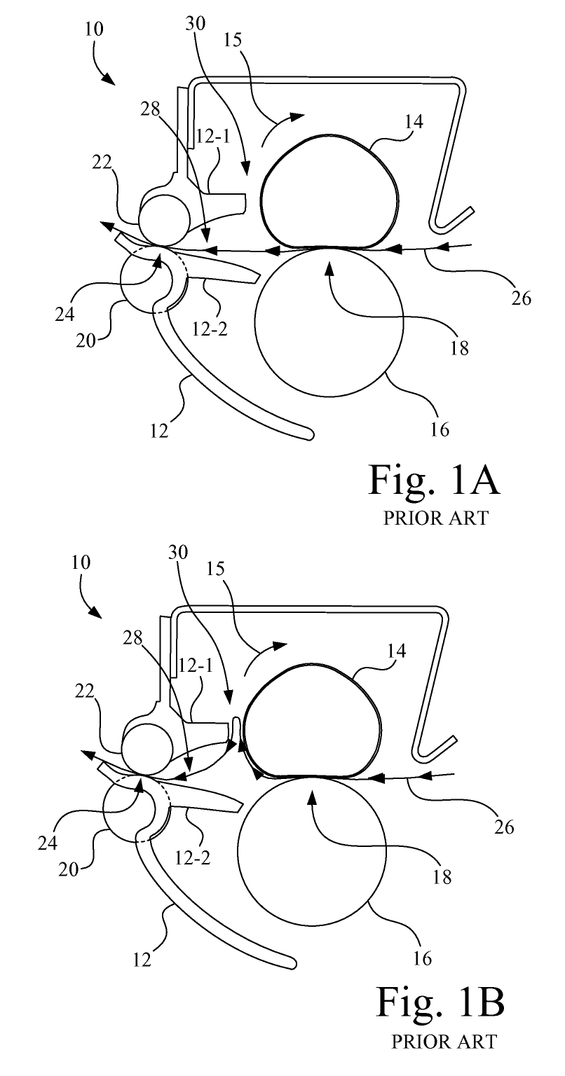

FIG. 2 is a diagrammatic representation of an electrophotographic imaging apparatus having a belt fuser assembly configured in accordance with an embodiment of the present invention.

FIG. 3 is a diagrammatic side view of a belt fuser assembly of the imaging apparatus of FIG. 2 configured in accordance with an embodiment of the present invention.

FIG. 4 is a perspective view of pivot body of the belt fuser assembly of FIG. 3.

FIG. 5 is a diagrammatic side view of a belt fuser assembly of FIG. 3, with the pivot body being positioned by a sheet of media to prevent wrapping of the sheet of media around the fuser belt during a sheet jam.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

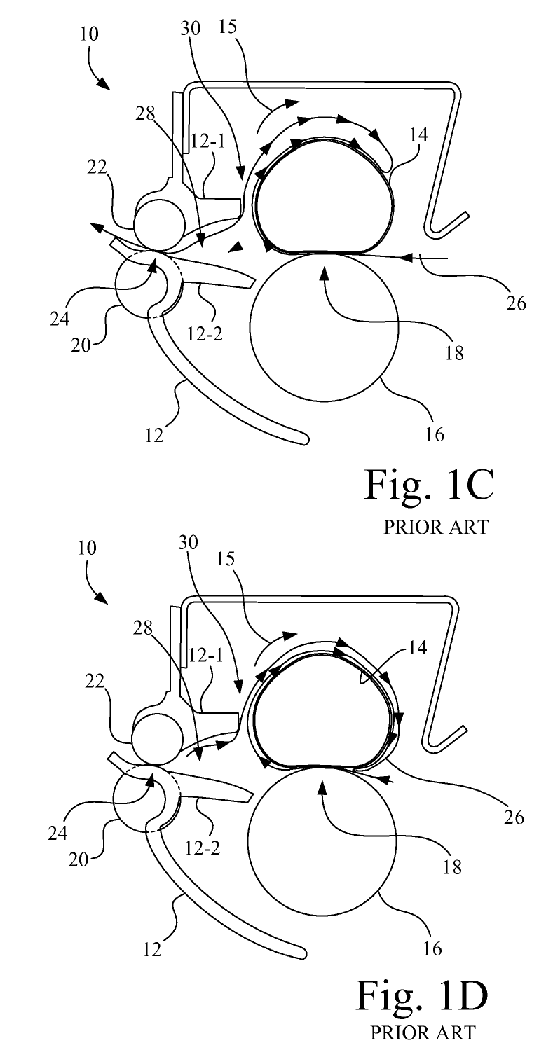

Referring now to the drawings and particularly to FIG. 2, there is shown an exemplary electrophotographic imaging apparatus 110, e.g., a laser printer and/or copier, configured in accordance with an embodiment of the present invention. Imaging apparatus 110 includes a media feed section 112, an image-forming device 114, a laser scanning device 116, and a belt fuser assembly 118.

Media feed section 112 sequentially transports a sheet of media (e.g., paper) 120-1 from a stack of sheets of media 120 to image-forming device 114. A media feed direction is indicated by the arrows on the sheet of media 120-1. Each sheet of media 120-1 moves along a media feed path 122 in a sheet feed direction 122-1. Image-forming device 114 transfers a toner image to the transported sheet of media 120-1. Belt fuser assembly 118 fixes the toner image to the sheet of media 120-1 sent from image-forming device 114. Thereafter, the sheet of media 120-1 is ejected out of imaging apparatus 110 by media transport rollers 124, 126 and into output tray 128.

In the exemplary imaging apparatus 110, the media feed section 112 includes a feed tray 130, a feed roller 132, a media separating friction plate 134, a pressure spring 136, a media detection actuator 138, a media detection sensor 140, and a control circuit 142. Upon receiving a print instruction, the sheets of media 120 which have been placed in media feed tray 130 are fed one-by-one by operation of feed roller 132, media separating friction plate 134 and pressure spring 136. As the fed sheet of media 120-1 pushes down media detection actuator 138, media detection sensor 140 outputs an electrical signal instructing commencement of printing of the image. Control circuit 142, started by operation of media detection actuator 138, transmits an image signal to a laser diode light-emitting unit 144 of laser scanning device 116 so as to control the ON/OFF condition of its associated light-emitting diode.

Laser scanning device 116 includes laser diode light-emitting unit 144, a scanning mirror 146, a scanning mirror motor 148, and reflecting mirrors 150, 152, and 154. Scanning mirror 146 is rotated at a constant high speed by scanning mirror motor 148 such that laser light beam 156 scans in a vertical direction to the print media surface. The laser light beam 156 radiated by laser diode light-scanning unit 144 is reflected by reflecting mirrors 150, 152, and 154 so as to be applied to a photosensitive body 158 of image-forming device 114. When the laser light beam 156 is applied to photosensitive body 158, photosensitive body 158 is selectively exposed to the laser light beam 156 in accordance with ON/OFF information from control circuit 142.

In addition to photosensitive body 158, image-forming device 114 includes a transfer roller 160, a charging member 162, and a developer, including a developing roller 164, a developing unit 166, and a cleaning unit 168. The surface charge of photosensitive body 158, charged in advance by charging member 162, is selectively discharged by the laser light beam 156. An electrostatic latent image is thus formed on the surface of photosensitive body 158. The electrostatic latent image is visualized by developing roller 164, and developing unit 166. Specifically, the toner supplied from developing unit 166 is adhered to the electrostatic latent image on photosensitive body 158 by developing roller 164 so as to form the toner image.

Toner used for development is stored in developing unit 166. The toner contains coloring components (such as carbon black for black toner) and thermoplastic components. The toner, charged by being appropriately stirred in developing unit 166, adheres to the above-mentioned electrostatic latent image by an interaction of the developing bias voltage applied to developing roller 164 and an electric field generated by the surface potential of photosensitive body 158, and thus conforms to the latent image, forming a visual toner image on photosensitive body 158. The toner typically has a negative charge when it is applied to the latent image, forming the visual toner image.

The sheet of media 120-1 transported from media feed section 112 is transported downstream while being pinched by photosensitive body 158 and transfer roller 160. The sheet of media 120-1 arrives at the transfer nip in timed coordination with the toned image on the photosensitive body 158. As the sheet of media 120-1 is transported downstream, the toner image formed on photosensitive body 158 is electrically attracted and transferred to the sheet of media 120-1 by an interaction with the electrostatic field generated by transfer voltage applied to transfer roller 160. Any toner that still remains on photosensitive body 158, not having been transferred to the sheet of media 120-1, is collected by cleaning unit 168. Thereafter, the sheet of media 120-1 is transported to belt fuser assembly 118.

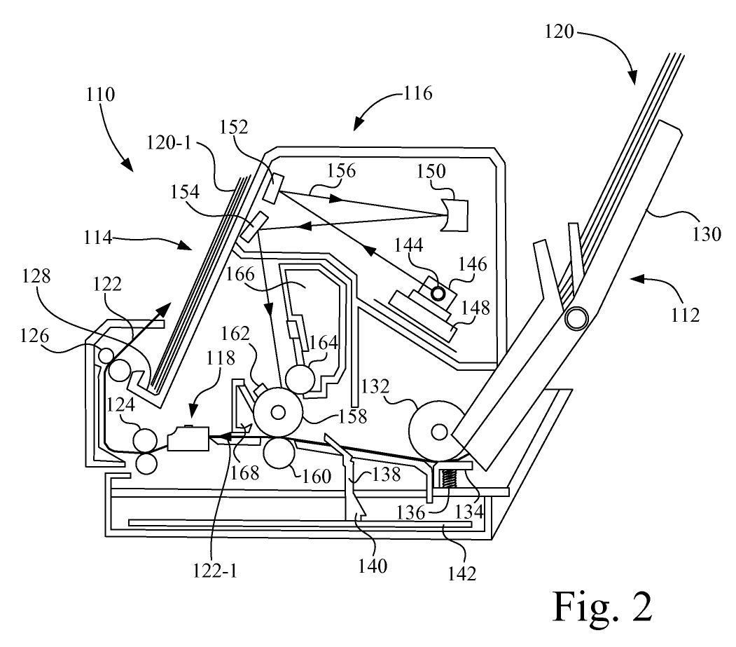

Referring now to FIG. 3, belt fuser assembly 118 is configured in accordance with an embodiment of the present invention.

Belt fuser assembly 118 includes a housing 172 which rotatably mounts a fuser belt 174 and a driven backup roller 176. Fuser belt 174 and a backup roller 176 engage to form a fuser nip 178. Housing 172 includes an upper exit guide 172-1 and a lower exit guide 172-2. Housing 172 further mounts an exit roller 180 and a corresponding idler roller 182. Exit roller 180 and idler roller 182 engage to form an exit nip 184.

Fuser belt 174 is rotated in a direction of rotation 175 by the sheet of media 120-1 moving through fuser nip 178. Fuser belt 174, subjected to heat, melts and fixes (i.e., fuses) the toner to the surface of the sheet of media 120-1, such as paper, thereby producing the printed image. Exit roller 180 and idler roller 182 transport the sheet of media 120-1 having the fused image out of belt fuser assembly 118.

The backup (i.e., pressure) roller 176 may be made from, or is coated with, a material that has good release and transport properties for the sheet of media being processed through belt fuser assembly 118. For example, backup roller 176 may have an aluminum core with a silicone rubber layer molded or adhesively bonded onto its surface, or alternatively, backup roller 176 may also have a fluoropolymer, e.g., Teflon® sleeve or coating. Backup roller 176 may be sufficiently soft so as to allow it to be rotated against fuser belt 174 at fuser nip 178. As a printed sheet of media 120-1 passes through fuser nip 178, the sheet is placed under pressure, and the combined effects of this pressure, the time the sheet is in fuser nip 178, and the heat from fuser belt 174 acts to fix the toner onto the sheet of media 120-1. Typically, the pressure between fuser belt 174 and backup roller 176 at fuser nip 178 is from about 5 pound per square inch (psi) to 30 psi.

Fuser belt 174 is an endless belt formed from a highly heat resistive and durable material having good parting properties and may have a thickness of about 75 microns or less. Fuser belt 174 may be formed, for example, from a polyimide film or metal. Fuser belt 174 may have an outer coating of, for example, a fluororesin or Teflon® material to optimize release properties of the fixed toner. Fuser belt 174 may be shaped, for example, as a tube. Fuser belt 174 is positioned between and supported by a pair of end caps (not shown). Additional internal support for fuser belt 174 is provided by a heater assembly 186 (see FIG. 3).

As illustrated in FIG. 3, heater assembly 186 is located in the hollow interior of fuser belt 174. Heater assembly 186 applies an appropriate temperature and pressure to fuser belt 174 while the sheet of media 120-1 is moving through fuser nip 178 formed by backup roller 176 and fuser belt 174. The thermoplastic components of the toner on the sheet of media 120-1 are melted by fuser belt 174 and fixed to the sheet of media 120-1 to form the fixed image.

Heater assembly 186 includes a heater housing 188. Heater housing 188 is configured to mount a heater body 190, and may be formed from a plastic material. Heater body 190 may be formed, for example, using a ceramic substrate having a series of thick film printed resistive materials, conductive materials, and insulative materials. Heater body 190 is positioned to contact an interior surface 174-1 of fuser belt 174, so that heater assembly 186 is thermally coupled to fuser belt 174. During normal operation, a gap 192 is present between heater housing 188 and interior surface 174-1 of fuser belt 174.

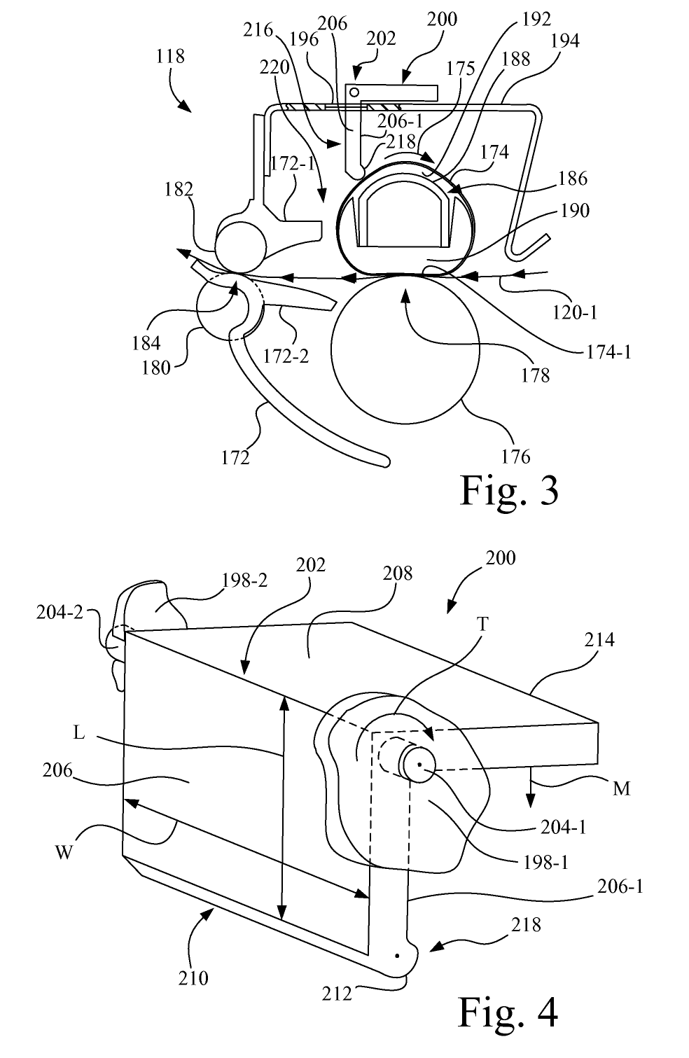

Referring to FIGS. 3 and 4, housing 172 includes a removable cover 194 that covers over fuser belt 174 and backup roller 176. An opening 196 is formed through cover 194. Cover 194 of housing 172 includes a pair of first pivot members 198-1, 198-2.

A pivot body 200 has a proximal portion 202 pivotably mounted to cover 194 of housing 172. Pivot body 200 may be formed, for example, from a high temperature reinforced plastic, such as by a molding process. A pair of second pivot members 204-1, 204-2 is located at proximal portion 202. The second pivot members 204-1, 204-2 of pivot body 200 respectively engage the first pivot members 198-1, 198-2 of cover 194 of housing 172 to form a pivoting connection between pivot body 200 and cover 194 of housing 172.

Pivot body 200 has a first elongate member 206 and a second elongate member 208. First elongate member 206 is positioned to extend downwardly through opening 196 of cover 194 of housing 172. In the present embodiment, pivot body 200 is formed as a rigid unitary structure.

First elongate member 206 extends from proximal portion 202 to a first distal end 210 of first elongate member 206. First elongate member 206 has a length L, and a width W extending perpendicular to the direction of rotation 175 of fuser belt 174. The first distal end 210 of first elongate member 206 has a smooth curved surface 212 extending along width W for pressing against fuser belt 174 during a sheet jam occurring in housing 172 to prevent the sheet of media 120-1 from wrapping around fuser belt 174.

Second elongate member 208 cantilevers outwardly from proximal portion 202 to a second distal end 214. Referring to FIG. 4, second elongate member 208 has a mass M selected to generate a torque T to pivot the first distal end 210 of first elongate member 206 to a normal position 216 (see FIG. 3) out of contact with fuser belt 174 in the absence of contact of first elongate member 206 by the sheet of media 120-1.

In the present exemplary embodiment, second elongate member 208 extends perpendicular to first elongate member 206 to form an L-shaped structure. Also, first distal end 210 of first elongate member 206 is configured with a head portion 218 that includes the smooth curved surface 212. Head portion 218 is configured to extend outside a plane of an interior planar surface 206-1 of first elongate member 206, and toward fuser belt 174.

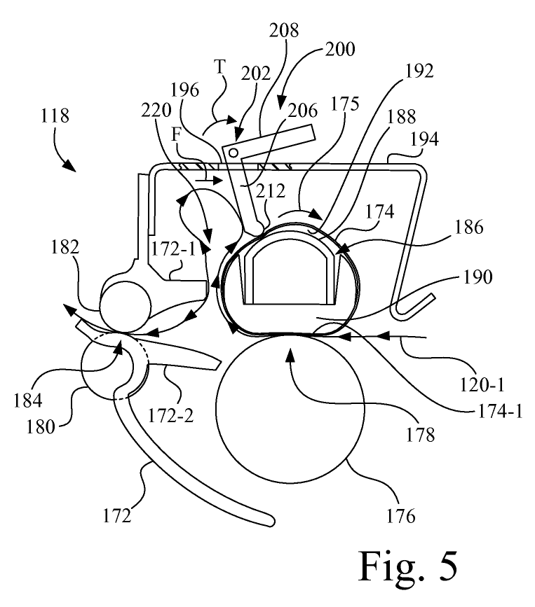

Referring also to FIG. 5, during a sheet jam, the sheet of media 102-1 applies a force F to first elongate member 206 sufficient to overcome torque T and pivot the smooth curved surface 212 at first distal end 210 of first elongate member 206 from the normal position 216 into contact with fuser belt 174.

More particularly, when jammed media begins to enter the region 220 from between upper exit guide 172-1 and fuser belt 174, the sheet of media 120-1 will come into contact with first elongate member 206 of pivot body 200, and pivot body 200 will rotate against fuser belt 174. This action prevents the sheet of media 120-1 from continuing around fuser belt 174, thereby preventing the sheet of media 120-1 from fully wrapping fuser belt 174. While the sheet of media 120-1 will remain jammed in region 220, the lack of fuser wrapping permits this type of jam to be removed without disassembly of belt fuser assembly 118, e.g., is user removable, whereas a fuser wrap (i.e., the sheet of media wrapping around fuser belt 174) is not removable without disassembly of the belt fuser assembly, e.g., is not user removable.

The pivot point of pivot body 200 may be placed such that it will be balanced in a free position, as shown in FIG. 3, without the use of springs. The pivot point is placed such that when pivot body 200 rotates against fuser belt 174, the fuser belt will be between first distal end 210 of first elongate member 206 of pivot body 200 and heater housing 188 (e.g., a steel heater frame support structure) within fuser belt 174.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A belt fuser assembly, comprising:
a housing;
a fuser belt rotatably mounted to said housing, said fuser belt having a direction of rotation; and
a pivot body having a proximal portion pivotably mounted to said housing and having a first elongate member, having a first distal end, that extends from said proximal portion, said first elongate member having a width extending perpendicular to said direction of rotation of said fuser belt, said first distal end of said first elongate member having a smooth curved surface extending along said width for pressing against said fuser belt during a sheet jam occurring in said housing to prevent a sheet of media from wrapping around said fuser belt.

2. The belt fuser assembly of claim 1, wherein said pivot body further includes a second elongate member that cantilevers outwardly from said proximal portion and has a mass that generates a torque to pivot said first distal end of said first elongate member to a normal position out of contact with said fuser belt in the absence of contact of said first elongate member by said sheet of media.

3. The belt fuser assembly of claim 2, wherein during said sheet jam said sheet of media applies a force to said first elongate member sufficient to overcome said torque and pivot said smooth curved surface at said first distal end of said first elongate member from said normal position into contact with said fuser belt.

4. The belt fuser assembly of claim 1, wherein said pivot body further includes a second elongate member extending from said proximal portion having a second distal end, said second elongate member extending perpendicular to said first elongate member.

5. The belt fuser assembly of claim 1, wherein said first distal end of said first elongate member is configured with a head portion that includes said smooth curved surface, said head portion being configured to extend outside a plane of an interior planar surface of said first elongate member toward said fuser belt.

6. An imaging apparatus for forming a toner image on a sheet of media, comprising:
a media feed section for feeding said sheet of media along a media feed path in a sheet feed direction;
a laser scanning device configured to produce a scanned light beam;
an image-forming device having a photosensitive body, and configured to use said scanned light beam to form a latent image on said photosensitive body and develop said latent image to form a toner image that is transferred to said sheet of media; and
a belt fuser assembly for fusing the toner image to said sheet of media, said belt fuser assembly including:
a housing;
a fuser belt rotatably mounted to said housing, said fuser belt having a direction of rotation; and
a pivot body having a proximal portion pivotably mounted to said housing and having a first elongate member, having a first distal end, that extends from said proximal portion, said first elongate member having a width extending perpendicular to said direction of rotation of said fuser belt, said first distal end of said first elongate member having a smooth curved surface extending along said width for pressing against said fuser belt during a sheet jam occurring in said housing to prevent a sheet of media from wrapping around said fuser belt.

7. The imaging apparatus of claim 6, wherein said pivot body further includes a second elongate member that cantilevers outwardly from said proximal portion and has a mass that generates a torque to pivot said first distal end of said first elongate member to a normal position out of contact with said fuser belt in the absence of contact of said first elongate member by said sheet of media.

8. The imaging apparatus of claim 7, wherein during said sheet jam said sheet of media applies a force to said first elongate member sufficient to overcome said torque and pivot said smooth curved surface at said first distal end of said first elongate member from said normal position into contact with said fuser belt.

9. The imaging apparatus of claim 6, wherein said pivot body further includes a second elongate member extending from said proximal portion having a second distal end, said second elongate member extending perpendicular to said first elongate member.

10. The imaging apparatus of claim 6, wherein said first distal end of said first elongate member is configured with a head portion that includes said smooth curved surface, said head portion being configured to extend outside a plane of an interior planar surface of said first elongate member toward said fuser belt.
